(19) United States
(12) Patent Application Publication
(10) Pub. No.: US 2020/0171436 A1
(43) Pub. Date: Jun. 4, 2020

(54) ULTRAPURE-WATER PRODUCTION SYSTEM

(71) Applicants: KURITA WATER INDUSTRIES LTD., Tokyo (JP); ASAHI KASEI KABUSHIKI KAISHA, Tokyo (JP)

(72) Inventors: Takahiro KAWAKATSU, Tokyo (JP); Hideaki IINO, Tokyo (JP); Masayuki KANEDA, Tokyo (JP); Daisuke SATO, Tokyo (JP)

(21) Appl. No.: 16/087,398

(22) PCT Filed: Mar. 24, 2017
(86) PCT No.: PCT/JP2017/011989

§ 371 Date: Sep. 21, 2018

(30) Foreign Application Priority Data
Mar. 25, 2016 (JP) 2016-062177

(51) Int. Cl. B01D 61/18; B01D 61/14; B01D 61/20; B01D 63/02; B01D 69/02; C02F 9/00

(52) U.S. Cl. CPC B01D 61/18; C02F 2001/427; B01D 61/147; B01D 61/20; B01D 63/02; B01D 69/02; C02F 9/00; B01D 2311/2619; B01D 2311/2623; B01D 2311/2634; B01D 2315/08; B01D 2325/02; B01D 2325/04; B01D 2325/16; B01D 2325/20; B01D 61/145

(57) ABSTRACT

The ultrapure-water production system includes an auxiliary treatment apparatus and a dead-end filtration apparatus. The auxiliary treatment apparatus treats water such that the number of microparticles present in water treated by the auxiliary treatment apparatus is 800 to 1200 particles/mL. The dead-end filtration apparatus includes a filtration membrane that is a microfiltration membrane having pores formed in the surface of the membrane at an opening ratio of 50% to 90% with a size of 0.05 to 1 μm, and having a thickness of 0.1 to 1 mm, or an ultrafiltration membrane having pores formed in the surface of the membrane with a size of 0.005 to 0.05 μm, the number of the pores being 1E13 to 1E15 pores/m², the ultrafiltration membrane having a thickness of 0.1 to 1 mm and a transmembrane pressure of 0.02 to 0.10 MPa at a permeation flux of 10 m³/m²/d.

### TECHNICAL FIELD

The present invention relates to an ultrapure-water production system including a filtration device that removes microparticles present in water. The present invention relates specifically to an ultrapure-water production system capable of removing microparticles having a size of 20 nm or less and, in particular, submicroscopic particles having a size of 10 nm or less at a high rejection rate in a subsystem or a feed path which is located upstream of the point-of-use and efficiently producing ultrapure water by performing dead-end membrane filtration.

### BACKGROUND ART

Ultrapure-water production and supply systems used in a semiconductor production process and the like typically have a structure as illustrated in FIG. 1. The system includes a cross-flow ultrafiltration membrane (UF membrane) device 17 for the removal of microparticles which is disposed at the rear end of a subsystem 3. The system is operated at a recovery rate of 90% to 99% and removes nanometer-sized microparticles. A mini-subsystem that serves as a point-of-use polisher may optionally be disposed immediately upstream of a cleaning machine used for cleaning semiconductors and electronic materials, the mini-subsystem including a UF membrane device for the removal of microparticles which is disposed at the rear end of the mini-subsystem. A UF membrane device for the removal of microparticles may also be disposed immediately upstream of a nozzle of the cleaning machine at the point-of-use in order to remove microparticles having a further small size at a high rejection rate.

Recently, the control over the microparticles contained in water has been increasingly tightened due to the development of semiconductor production processes. International Technology Roadmap for Semiconductors (ITRS) requests that the certified value for the number of microparticles having a size of more than 11.9 nm being less than 1,000 particle/L (control value: less than 100 particle/L) be achieved by the year 2019.

Technologies for removing impurities contained in water, such as microparticles, at a high rejection rate and increasing the purity of the water produced with an ultrapure-water production apparatus are disclosed in the following patent documents.

Patent Literature 1 describes a technology in which pressure filtration is performed with an ultrafiltration membrane at a recovery rate of 97% to 99.9% in the subsystem. However, in Patent Literature 1, it is considered that performing filtration at a recovery rate of 100%, that is, dead-end filtration, causes microparticles present in water to gradually accumulate on the surface of the membrane, which results in a reduction in the amount of water that permeates through the membrane with time, and it is therefore difficult to operate the filtration device at a recovery rate of 100%.

Patent Literature 2 describes a technology in which viable bacteria and microparticles are removed with an electrodeionization device disposed in the subsystem. However, a continuous operation of the electrodeionization device requires the permeation of the rejected substance through an ion-exchange membrane included in the device, while the microparticles are not capable of passing through the ion-exchange membrane. Therefore, it is not possible to use the electrodeionization device for removing microparticles.

Patent Literature 3 describes a technology in which a membrane separation unit is disposed in any of the components of an ultrapure-water supply apparatus, that is, a pretreatment device, a primary pure water device, a secondary pure water device (i.e., a subsystem), and a recovery device, and a reverse osmosis membrane that has been treated such that the elution of amine from the reverse osmosis membrane can be reduced is disposed downstream of the membrane separation unit. While it is possible to remove microparticles with a reverse osmosis membrane, it is not preferable to use a reverse osmosis membrane for the following reasons. Specifically, it is necessary to increase pressure for operating a reverse osmosis membrane. In addition, the amount of water that permeates through the membrane is small, that is, about 1 m³/m²/day at a pressure of 0.75 MPa. On the other hand, the amount of water treated with current systems that use a UF membrane is 7 m³/m²/day at a pressure of 0.1 MPa, which is 50 times or more the amount of water that permeates through a reverse osmosis membrane. It is necessary to use a reverse osmosis membrane having a considerably large area for treating an amount of water which is comparable to the amount of water treated with a UF membrane. Furthermore, it is necessary for using a reverse osmosis membrane to drive a booster pump, which may generate additional unwanted microparticles and metals.

Patent Literature 4 describes a technology in which a functional material or a reverse osmosis membrane that includes an anionic functional group is disposed downstream of a UF membrane included in an ultrapure water line. The functional material or the reverse osmosis membrane that includes an anionic functional group is provided for reducing the amount of amines and not suitable for removing the microparticles having a size of 10 nm or less, which are to be removed in the present invention. In addition, it is not preferable to use a reverse osmosis membrane as in Patent Literature 3.

Patent Literature 5 describes a technology in which a reverse osmosis membrane device is disposed upstream of a UF membrane device located at the rear end of the subsystem. Patent Literature 5 has the same problem as in Patent Literature 3.

Patent Literature 6 describes a technology in which the particles are removed through a prefilter included in a membrane module constituting an ultrapure-water production line. An object of Patent Literature 6 is to remove particles having a size of 0.01 mm or more. Patent Literature 6 is not possible to remove microparticles having a size of 10 nm or less, which are to be removed in the present invention.

Patent Literature 7 describes a technology in which water treated with an electrodeionization device is filtered through a UF-membrane filtration device including a filtration membrane that is not modified with an ion-exchange group and the permeate is treated with a membrane filtration device including an MF membrane modified with an ion-exchange group. Patent Literature 6 describes only examples of the ion-exchange group, which are cation-exchange groups such as a sulfonic group and an iminodiacetic acid group. Patent Literature 6 describes nothing about the types of the ion-exchange group and the targets that can be removed with the respective types of the ion-exchange group, although the definition of ion-exchange groups include anion-exchange groups.

Patent Literature 8 describes a technology in which an anion-adsorption membrane device is disposed downstream of a UF membrane device included in the subsystem. Patent Literature 8 describes the results of tests in which silica was used as a target to be removed are described therein. Patent Literature 8 does not describe the types of the anion-exchange group and the sizes of the microparticles. Since it is commonly known that the removal of ionic silica requires a strong-anion-exchange group (DIAION: Manual of Ion Exchange Resins and Synthetic Adsorbent, Volume 1, Mitsubishi Chemical Corporation, p. 15), it is considered that a membrane including a strong-anion-exchange group is used in Patent Literature 8.

Patent Literatures 9 and 10 disclose polyketone membranes modified with various functional groups. The membranes are used as a membrane constituting a separator included in a capacitor, a battery, or the like. In Patent Literature 10, the use of the polyketone membranes as a filter for water treatment is also described. However, it is not suggested that, among the modified polyketone membranes, a polyketone membrane modified with a weakly cationic functional group is particularly suitably used in an ultrapure-water production and supply system for removing submicroscopic particles having a size of 10 nm or less.

Patent Literature 11 describes a porous polyketone membrane including one or more functional groups selected from the group consisting of a primary amino group, a secondary amino group, a tertiary amino group, and a quaternary ammonium salt and having a negative-ion-exchange capacity of 0.01 to 10 milliequivalent/g. The above porous polyketone membrane is capable of efficiently removing impurities such as microparticles, gels, and viruses in the fields of the production of semiconductors and electronic components, biomedicines, chemicals, and food manufacture. Patent Literature 11 suggests that the 10-nm microparticles and anionic particles smaller than the pores of the porous membrane may be removed.

However, it is not descried in Patent Literature 11 that the porous polyketone membrane may be used in an ultrapure-water production process. Patent Literature 11 describes that both a strongly cationic quaternary ammonium salt and a weakly cationic amino group can be equivalently used as a functional group introduced to the porous polyketone membrane. Patent Literature 11 does not describe the impacts of changing the type (e.g., cation strength) of the functional group on the production of ultrapure water.

The size of the pores formed in the above membrane used for removing microparticles is larger than the sizes of microparticles. It is considered that microparticles are not blocked in the pores but are removed by being adsorbed on the surface of the membrane due to the charge of the surface.

Patent Literature 1: JP S59-127611 A

Patent Literature 2: Japanese Patent No. 3429808

Patent Literature 3: Japanese Patent No. 3906684

Patent Literature 4: Japanese Patent No. 4508469

Patent Literature 5: JP H5-138167 A

Patent Literature 6: Japanese Patent No. 3059238

Patent Literature 7: JP 2004-283710 A

Patent Literature 8: JP H10-216721 A

Patent Literature 9: JP 2009-286820 A

Patent Literature 10: JP 2013-76024 A

Patent Literature 11: JP 2014-173013 A

As described above, the ultrapure-water production systems disclosed in the related art are not capable of removing microparticles having a size of 20 nm or less and, in particular, submicroscopic particles having a size of 10 nm or less from water at a high rejection rate. In addition, no attempt has been made to operate the above ultrapure-water production systems at a recovery rate of 100%, that is, in a dead-end filtration mode. Accordingly, the above ultrapure-water production systems are not capable of producing ultrapure water having a sufficiently high purity. Moreover, increases in the functionality of the subsystem have increased the initial costs. Furthermore, discharging part of water treated by the mixed-bed ion-exchange device, which does not need to be disposed of originally, has increased the running costs.

### SUMMARY OF INVENTION

An object of the present invention is to provide an ultrapure-water production system capable of removing microparticles having a size of 20 nm or less and, in particular, microparticles having a size of 10 nm or less from water in a subsystem or the like located upstream of the point at which ultrapure water is used and producing ultrapure water with high efficiency at a high flow rate.

The ultrapure-water production system of the present invention comprises an auxiliary treatment apparatus and a dead-end filtration apparatus that treats water treated by the auxiliary treatment apparatus,

the auxiliary treatment apparatus treating water such that the number of microparticles present in water treated by the auxiliary treatment apparatus is 800 to 1200 particles/mL (particle size: 20 nm or more), the number of microparticles being measured by a 60-minute moving average method with an online particle monitor Ultra-DI20 produced by Particle Measuring Systems capable of measuring microparticles having a size of 20 nm with a detection sensitivity of 5% and a measurement error of ±20%, the online particle monitor receiving the water treated by the auxiliary treatment apparatus through a sampling cock disposed on a main pipe,

the dead-end filtration apparatus including a filtration membrane, the filtration membrane being a microfiltration membrane having pores with a size of 0.05 to 1 μm, the pores being formed in the surface of the membrane at an opening ratio of 50% to 90%, the microfiltration membrane having a thickness of 0.1 to 1 mm, or an ultrafiltration membrane having pores with a size of 0.005 to 0.05 μm, the pores being formed in the surface of the membrane, the number of the pores being 1E13 to 1E15 pores/m², the ultrafiltration membrane having a thickness of 0.1 to 1 mm, the ultrafiltration membrane having a transmembrane pressure of 0.02 to 0.10 MPa at a permeation flux of 10 m³/m²/d.

The pore size can be measured by perm porometry and is the pore size corresponding to the pressure at which the air permeation rate is 50% of the maximum air permeation rate.

In an embodiment of the present invention, the dead-end filtration apparatus has a membrane area of 10 to 50 m² and the amount of water that passes through the dead-end filtration apparatus per membrane module is 10 to 50 m³/h.

In an embodiment of the present invention, the dead-end filtration apparatus is an outside-in hollow fiber membrane module.

In an embodiment of the present invention, the filtration membrane includes a cationic functional group.

In an embodiment of the present invention, 50% or more of the membrane includes a weakly cationic functional group.

In an embodiment of the present invention, an amount of the cationic functional group included in the membrane is 0.01 to 1 milliequivalents per gram of the membrane.

In an embodiment of the present invention, the auxiliary treatment apparatus includes a feed pump and a mixed-bed ion-exchange device that are arranged in this order from upstream to downstream, and wherein the dead-end filtration apparatus treats water treated by the mixed-bed ion-exchange device.

In an embodiment of the present invention, the auxiliary treatment apparatus further includes a UV oxidation device and a catalytic oxidizing-substance decomposition device that are arranged upstream of the feed pump in this order from upstream to downstream.

### Advantageous Effects of Invention

The inventor of the present invention found that a membrane having a microparticle-capturing capability adequate to the number of microparticles present in the feed is capable of consistently producing ultrapure water from which microparticles having a size of 20 nm or less and, in particular, submicroscopic particles having a size of 10 nm or less have been removed at a high rejection rate at a recovery rate of 100%, that is, in a dead-end filtration mode, with high efficiency without a reduction in the amount of permeate due to clogging of the membrane, cleaning, or replacement. The inventor of the present invention also found that the number of microparticles present in the membrane feed can be controlled by optimizing the layout of the units constituting the subsystem. The inventor of the present invention also found that using a microfiltration membrane (MF membrane) or UF membrane that includes a cationic group or, in particular, a tertiary amino group that is a weakly cationic functional group may reduce the generation of dust particles from the filtration membrane and, consequently, enables ultrapure water to be consistently produced over a longer period of time.

The present invention was made on the basis of the above findings.

The ultrapure-water production system according to the present invention is capable of removing microparticles having a size of 20 nm or less and, in particular, submicroscopic particles having a size of 10 nm or less from water at a high rejection rate and producing ultrapure water at a high flow rate. The ultrapure-water production system according to the present invention can be consistently operated for three or more years without replacing or cleaning the membrane.

The ultrapure-water production system according to the present invention is particularly suitable as a subsystem or feed path disposed upstream of the point-of-use in an ultrapure-water production and supply system.

### BRIEF DESCRIPTION OF DRAWINGS

FIG. 1 is a flow diagram illustrating an ultrapure-water production system according to an embodiment of the present invention.

FIG. 2 is a flow diagram illustrating an ultrapure-water production system according to an embodiment of the present invention.

FIG. 3 is a flow diagram illustrating an ultrapure-water production system used in a comparative example.

### DESCRIPTION OF EMBODIMENTS

The ultrapure-water production system according to the present invention preferably includes at least a feed pump, a mixed-bed ion-exchange device, and a microparticle removal membrane device that are arranged in this order. In this ultrapure-water production system, the microparticles generated from the feed pump do not directly place a load on the filtration membrane. This enables the ultrapure-water production system to consistently operate in a dead-end filtration mode.

The mixed-bed ion-exchange resin preferably has a uniform particle size such that the average particle size is 500 to 750 μm. The mixing ratio between a strongly cationic ion-exchange resin and a strongly anionic ion-exchange resin included in the mixed-bed ion-exchange device is desirably 1:1 to 1:8. The mixed-bed ion-exchange device is preferably capable of reducing the number of microparticles having a size of 20 nm or more which are present in the water that is to be treated to 800 to 1,200 particles/mL when operated at an SV of 50 to 120/h.

It is more preferable to arrange a catalytic oxidizing-substance decomposition device upstream of the feed pump and a UV oxidation device upstream of the catalytic oxidizing-substance decomposition device. When TOC constituents are decomposed in the UV oxidation device, hydrogen peroxide is generated as a by-product. The hydrogen peroxide reacts with and degrades an ion-exchange resin included in the mixed-bed ion-exchange device and, consequently, causes the generation of microparticles (generation of dust particles). The microparticles are likely to cause clogging of pores formed in the membrane surface, which makes it impossible to produce a predetermined amount of permeate. Accordingly, it is desirable to arrange the UV oxidation device, the catalytic oxidizing-substance decomposition device, the mixed-bed ion-exchange device, and the microparticle removal membrane device in this order and the feed pump upstream of the mixed-bed ion-exchange device.

FIG. 2 illustrates an example of the flow of the steps conducted by an ultrapure-water production system according to the present invention.

The ultrapure-water production system illustrated in FIG. 2 includes a pretreatment system 1, a primary pure water system 2, and a subsystem 3.

The pretreatment system 1 includes a coagulation device, a pressure flotation (sedimentation) device, a filtration device, and the like and removes suspended solids and colloidal substances contained in the raw water. The primary pure water system 2 includes a reverse osmosis (RO)-membrane separation device, a deaeration device, and an ion-exchange device (mixed-bed, two-bed-three-column, or four-bed-five-column) and removes ions and organic components contained in the raw water. The RO-membrane separation device removes salts and ionic, neutral, and colloidal TOC components. The ion-exchange device removes salts and TOC components that can be removed with an ion-exchange resin by adsorption or ion exchange. The deaeration device (nitrogen deaeration or vacuum deaeration) removes dissolved oxygen.

The primary pure water (normally, pure water having a TOC concentration of 2 ppb or less) is treated in the subsystem 3 to produce ultrapure water. In FIG. 2, the primary pure water is passed through a subtank 11, a pump P₁, a heat exchanger 12, a UV oxidation device 13, a catalytic oxidizing-substance decomposition device 14, a degassing device 15, a pump P₂, a mixed-bed ion-exchange device 16, and a dead-end filtration, microparticle removal membrane device 17 sequentially in this order. The resulting ultrapure water is transported to a point-of-use 4. The subtank 11, the mixed-bed ion-exchange device 16, and the components interposed therebetween constitute the auxiliary treatment apparatus.

The UV oxidation device 13 is an UV oxidation device that emits an UV ray having a wavelength of about 185 nm, which is used in an ultrapure-water production system, such as an UV oxidation device including a low-pressure mercury lamp. The UV oxidation device 13 decomposes the TOC components contained in the primary pure water into organic acids and, finally, into CO₂. An excess UV ray emitted from the UV oxidation device 13 converts water into H₂O₂.

The water treated in the UV oxidation device is passed into the catalytic oxidizing-substance decomposition device 14. Examples of the oxidizing-substance decomposition catalyst included in the catalytic oxidizing-substance decomposition device 14 include the noble metal catalysts known as redox catalysts, such as palladium (Pd) compounds (e.g., metal palladium, palladium oxide, and palladium hydroxide) and platinum (Pt). Among the above catalysts, in particular, palladium catalysts are suitably used since they have a high reducing power.

This catalytic oxidizing-substance decomposition device 14 efficiently decomposes and removes H₂O₂ generated in the UV oxidation device 13 and other oxidizing substances with the catalyst. Since the decomposition of H₂O₂ produces water but hardly produce oxygen in contrast to the decomposition of H₂O₂ with an anion-exchange resin or an active carbon, it does not increase the amount of DO.

The water treated in the catalytic oxidizing-substance decomposition device 14 is passed into the deaeration device 15. The deaeration device 15 may be a vacuum deaeration device, a nitrogen deaeration device, or a membrane deaeration device. The deaeration device 15 efficiently removes DO and CO₂ contained in water.

The water treated in the deaeration device 15 is passed into a mixed-bed ion-exchange device 16 through a pump P₂. The mixed-bed ion-exchange device 16 is a nonregenerative mixed-bed ion-exchange device including an anion-exchange resin and a cation-exchange resin that are mixed in accordance with ionic load. The mixed-bed ion-exchange device 16 removes the cations and anions contained in water and increases the purity of the water.

The water treated by the mixed-bed ion-exchange device 16 is passed into the dead-end filtration, microparticle removal membrane device 17. The microparticle removal membrane device 17 removes microparticles present in the water, such as the particles of ion-exchange resins discharged from the mixed-bed ion-exchange device 16.

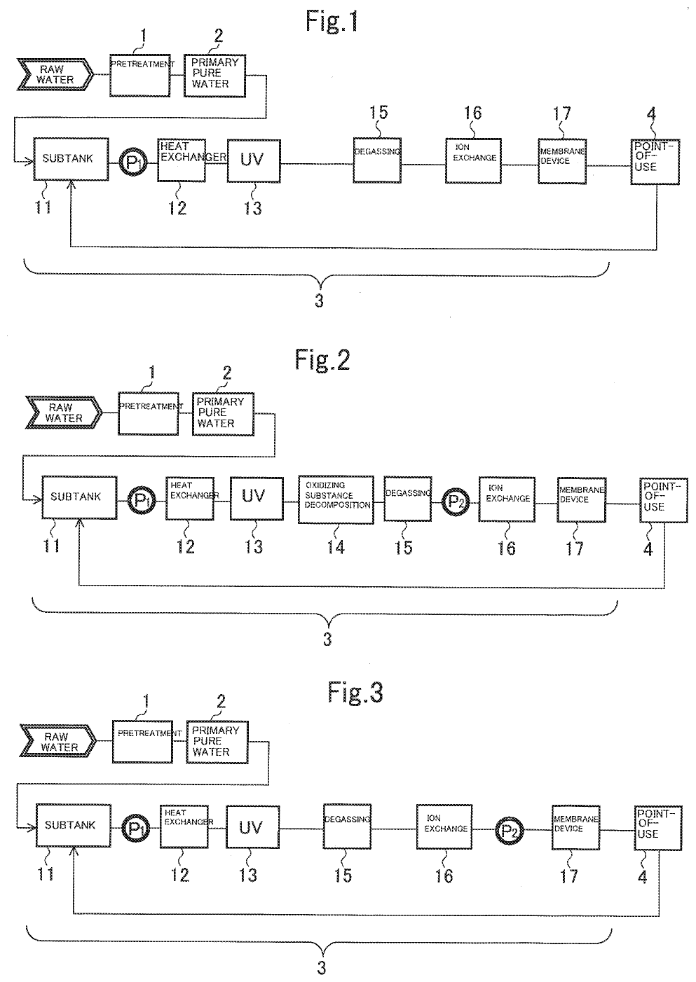

The structure of the ultrapure-water production system according to the present invention is not limited to that illustrated in FIG. 2. For example, the pump P₂ disposed upstream of the mixed-bed ion-exchange device may be omitted (FIG. 1). The catalytic oxidizing-substance decomposition device 14 may be omitted (FIG. 1). The pump P₂ may be interposed between the mixed-bed ion-exchange device 16 and the microparticle removal membrane device 17 (FIG. 3). Note that, it is preferable to arrange the mixed-bed ion-exchange device 16 downstream of the pump P₂ in order to remove the dust particles generated from the pump P₂ by the mixed-bed ion-exchange device 16. The catalytic oxidizing-substance decomposition device 14 and the degassing device 15 may be omitted such that the water treated by UV irradiation in the UV oxidation device 13 is fed directly to the mixed-bed ion-exchange device 16. An anion-exchange column may be used instead of the catalytic oxidizing-substance decomposition device 14.

An RO-membrane separation device may be optionally disposed downstream of the mixed-bed ion-exchange device 16. The ultrapure-water production and supply system according to the present invention may further include a device that decomposes urea and other TOC components contained in the raw water by pyrolysis under an acidic condition of a pH of 4.5 or less in the presence of an oxidizing agent and subsequently performs deionization. The UV oxidation device, the mixed-bed ion-exchange device, the deaeration device, or the like may be disposed at multiple stages. The structures of the pretreatment system 1 and the primary pure water system 2 are also not limited to the above-described structures and may include any combination of devices.

### Auxiliary Treatment Apparatus

In FIGS. 1 to 3, the components disposed upstream of the microparticle removal membrane device 17 constitute an auxiliary treatment apparatus. The auxiliary treatment apparatus preferably treats the membrane feed such that the number of microparticles present in the membrane feed is 800 to 1200 particles/mL (particle size: 20 nm or more), the number of microparticles being measured by a 60-minute moving average method with an online particle monitor Ultra-D120 produced by Particle Measuring Systems capable of measuring microparticles having a size of 20 nm with a detection sensitivity of 5% and a measurement error of ±20%, the online particle monitor receiving the membrane feed through a sampling cock disposed on a main pipe. The membrane device to which the membrane feed containing a known number of microparticles is fed is capable of consistently operating in a dead-end filtration mode without clogging of the membrane and enables high-purity ultrapure water to be produced with high efficiency.

The size of pores formed in the surface of the membrane, the opening ratio of the surface of the membrane, and the thickness of the membrane affect the capability of the membrane to capture the microparticles.

### Microparticle Removal Membrane Device

A dead-end filtration microparticle removal membrane device included in the ultrapure-water production system according to the present invention is described below in detail.

### Membrane Material

The microfiltration membrane and ultrafiltration membrane used as a filtration membrane included in the microparticle removal membrane device are as follows.

The microfiltration membrane has pores with an average size of 1 μm or less. Specifically, the microfiltration membrane has pores with a size of 0.05 to 1 μm and, in particular, pores with a size of 0.05 to 0.5 μm which are formed in the surface of the membrane at an opening ratio of 50% to 90%. The microfiltration membrane has a thickness of 0.1 to 1 mm.

The ultrafiltration membrane has pores with a size of 0.005 to 0.05 μm formed in the surface of the membrane. The number of the pores is 10¹³ to 10¹⁵ (1E13 to 1E15) pores/m².

The ultrafiltration membrane has a thickness of 0.1 to 1 mm. The ultrafiltration membrane has a transmembrane pressure of 0.02 to 0.10 MPa at a permeation flux of 10 m³/m²/d.

An observation of the above filtration membranes with a scanning electron microscope confirms that the numbers of pores of the filtration membranes vary even among filtration membranes that have the same nominal pore size and are produced in the same production lot. However, a microparticle removal membrane device that includes a filtration membrane that falls within the above range is capable of consistently operating without clogging over a long period of time. If the filtration membrane is used under conditions that do not fall within the above range, the membrane is likely to become clogged, and the number of microparticles present in the treated water may not fall within the desired range.

The numbers of pores of the filtration membranes are measured by direct observation with a scanning electron microscope. Specifically, it is preferable to divide a hollow fiber membrane into 5 segments in the longitudinal direction, observe each of the segments with a scanning electron microscope (SEM) in 100 fields of view, and calculate the average of the numbers of pores measured in the 100 fields of view. The larger than 100 the number of the fields of view, the higher the accuracy. It is preferable to average the numbers of pores measured in about 100 to 10000 fields of view for accuracy purposes.

It is possible to consistently operate the apparatus in a dead-end filtration mode by optimizing the relationship between the number of pores and thickness of the above dead-end filtration membrane and the number of microparticles present in the water that is to be treated.

The filtration membrane may be a cationic filtration membrane. The cationic filtration membrane is described below in detail.

### Membrane Module

The above filtration membrane is accommodated in a housing to form a membrane module. The membrane is preferably a hollow fiber membrane that allows a large surface area of the membrane to be maintained efficiently in the housing having a limited volume and may be a pleated membrane or a flat membrane.

Hollow fiber membranes are likely to become contaminated in the spinning process, in which the outer surfaces of the hollow fibers are always exposed to the air. For the above reason, hollow fiber membranes are preferably operated in an outside-in mode. Hollow fiber membranes may also be operated in an inside-out mode after the outer surfaces of hollow fibers have been cleaned. The filtration membrane is commonly composed of a material such as polysulfone, polyester, or PVDF. The material for the filtration membrane is not limited. Note that, microfiltration membranes allow the microparticles to leak into the treated water. Thus, a microfiltration membrane that includes the cationic functional group described below is used in order to achieve the performance comparable to that of ultrafiltration membranes.

### Membrane Area

The area of the membrane per module is desirably 10 to 50 m² but not limited to this. The shape of the membrane should be selected for each of the plants in which the membrane is used such that the installation area and the cost are minimized.

### Transmembrane Pressure

The transmembrane pressure per module is desirably 0.02 to 0.10 MPa at a permeation flux of 10 m³/m²/d but not limited to this. The transmembrane pressure is set in accordance with the head of a pump included in the plant in which the membrane is used.

### Flow rate of Permeate

The flow rate of water (flow rate of permeate) per module is desirably 10 to 50 m³/h but not limited to this. Similarly to the membrane area, the shape of the membrane should be selected such that the installation area and the cost are minimized. The flow rate of water is not limited to this since it varies with the frequency at which the membrane is replaced and the desired qualities of the treated water.

### Dead-End Filtration Mode Operation

In the present invention, the microparticle removal membrane device is operated in a dead-end filtration mode during normal operation. A dead-end filtration mode is an operation mode in which water is taken under the condition of 100% recovery rate and water is not passed into a concentration line, except during a test run at the apparatus start-up and during maintenance. The housing of the membrane module is preferably provided with an air vent disposed thereon since it is necessary to remove air in a test run and in early stages of start-up subsequent to maintenance. There may be cases where a trace amount of water is discharged in order to remove unwanted air bubbles mixed in the feed. The expression “trace amount” used herein means discharging a certain amount of water such that the recovery rate is 99.9% to 100%. Therefore, the cases where the recovery rate is set to 99.9% and about 0.1% of the amount of water is discharged are included in the scope of the present invention.

### Cationic Filtration Membrane

The microparticle removal membrane used for producing the permeate in a dead-end filtration mode may be a microparticle removal membrane that includes a cationic functional group. In particular, a microparticle removal membrane that includes a weakly cationic functional group is effectively used because it reduces the elution of amine.

The cation exchange membrane may be composed of any material.

Examples of such an cation exchange membrane include a polyketone membrane, a mixed cellulose ester membrane, a polyethylene membrane, a polysulfone membrane, a polyether sulfone membrane, a polyvinylidene fluoride membrane, and a polytetrafluoroethylene membrane. A polyketone membrane is preferable because it has a large surface opening ratio, which enables a high flux to be achieved even at a low pressure, and enables a weakly cationic functional group to be readily introduced to the MF or UF membrane by chemical modification as described below.

The polyketone membrane is a porous polyketone membrane containing 10% to 100% by mass polyketone which is a copolymer of carbon monoxide with one or more olefins and may be produced by a publicly known method (e.g., JP 2013-76024 A or WO 2013-035747 A).

An MF or UF membrane that includes a charged functional group captures and removes microparticles present in water due to the electrical adsorptive activity thereof. The size of pores formed in the MF or UF membrane may be larger than the size of the microparticles that are to be removed. However, if the size of the pores of the MF or UF membrane is excessively large, the efficiency of removal of the microparticles becomes degraded. On the other hand, if the size of the pores of the MF or UF membrane is excessively small, the pressure required by membrane filtration may be increased disadvantageously. Accordingly, when an MF membrane is used, the size of pores of the MF membrane is preferably about 0.05 to about 0.2 μm. When a UF membrane is used, the size of pores of the UF membrane is preferably about 0.005 to about 0.05 μm.

The charged functional group may be directly introduced to a polyketone membrane or the like that constitutes the MF or UF membrane by chemical modification. The charged functional group may also be introduced to the MF or UF membrane as a result of a compound or ion-exchange resin including the charged functional group being deposited on the MF or UF membrane.

Examples of the method for producing a porous membrane that serves as the MF or UF membrane including a charged functional group include, but are not limited to, the following methods. The following methods may be used in combination of two or more.

(1) Directly introduce the charged functional group to the porous membrane by chemical modification.

For example, one of the methods for introducing a weakly cationic amino group to a polyketone membrane by chemical modification is to chemically react the polyketone membrane with a primary amine. It is preferable to use a multifunctional amine, such as a diamine, a triamine, a tetraamine, or a polyethyleneimine, which includes a primary amine (e.g., ethylenediamine, 1,3-propanediamine, 1,4-butanediamine, 1,2-cyclohexanediamine, N-methylethylenediamine, N-methylpropanediamine, N,N-dimethylethylenediamine, N,N-dimethylpropanediamine, N-acetylethylenediamine, isophoronediamine, or N,N-dimethylamino-1,3-propanediamine), because it enables the formation of a number of active sites. It is more preferable to use N,N-dimethylethylenediamine, N,N-dimethylpropanediamine, N,N-dimethylamino-1,3-propanediamine, or polyethyleneimine in order to introduce a tertiary amine to the polyketone membrane.

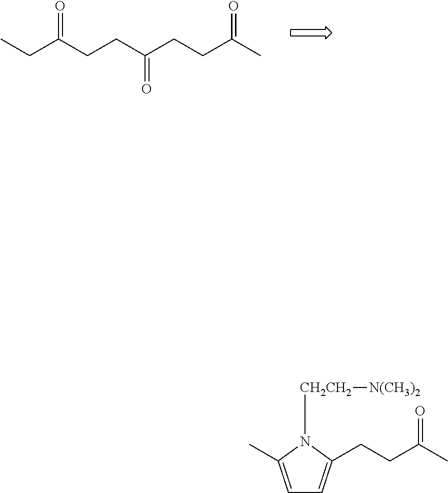

(2) Use two porous membranes and interpose an ion-exchange resin (for example, a resin including the weakly cationic functional group), which may be pulverized as needed, therebetween.

(3) Fill the inside of a porous membrane with the particles of the ion-exchange resin. For example, the ion-exchange resin is added to a porous-membrane-forming solution, and a membrane including the particles of the ion-exchange resin is formed using the solution.

(4) Deposit a charged compound or polyelectrolyte on the porous membrane or coat the porous membrane with a charged compound or polyelectrolyte by immersing the porous membrane in a charged compound or polyelectrolyte solution or by passing the charged compound or polyelectrolyte solution through the porous membrane. Examples of the compound containing the weakly cationic functional group or polyelectrolyte, such as a tertiary amine, include N,N-dimethylethylenediamine, N,N-dimethylpropanediamine, N,N-dimethylamino-1,3-propanediamine, polyethyleneimine, amino-group-containing poly(meth)acrylic acid ester, and amino-group-containing poly(meth)acrylamide.

(5) Introduce the charged functional group to the porous membrane composed of polyethylene or the like by graft polymerization.

(6) Prepare a polymer solution that contains a polymer including a charged functional group and a polyelectrolyte and form the polymer solution into a membrane by phase separation or electrospinning in order to prepare a porous membrane that includes a charged functional group.

The amount of charged functional group included in the MF or UF membrane is preferably, but not limited to, an amount at which the ratio of improvement in microparticle removal capability is 10 to 10000.

An MF or UF membrane that includes a weakly cationic functional group is capable of rejecting microparticles having a size of 20 nm or less and, in particular, microparticles having a size of 10 nm or less at a high rejection rate due to the adsorption action on the weakly cationic functional group. In addition, there is little risk of the weakly cationic functional group detaching from the MF or UF membrane and causing elution of TOC. For the above reasons, an MF or UF membrane that includes a weakly cationic functional group is suitably used in a microparticles removal device included in an ultrapure-water production and supply system. The MF or UF membrane is capable of reducing the generation of dust particles from the filter since it includes a cationic functional group. It is preferable to use a filter prepared from monomers modified with a cationic functional group. It is particularly preferable to use a filter composed of a polymer modified with a cationic functional group.

### EXAMPLES

The present invention is described more specifically below with reference to Examples and Comparative examples.

### Example 1

The system illustrated in FIG. 1 was used. Water that had been passed through a mixed-bed ion-exchange device in order to reduce the number of microparticles present in the water was used as feed to a microparticle removal membrane device. The number of microparticles having a size of 20 nm or more present in the feed, which was measured by a 60-minute moving average method with an online particle monitor Ultra-DI20 produced by Particle Measuring Systems, was 1,000 particles±20%/mL. The feed was passed into the microparticle removal membrane device at 16.6 L/min and treated in the device. The recovery rate was set to 100%. The microparticle removal membrane device was operated in a dead-end filtration mode to produce membrane permeate.

The filtration membrane included in the microparticle removal membrane device 17 was an ultrafiltration membrane (UF membrane) that was an outside-in hollow fiber membrane having the following properties: material: polysulfone, average pore size: 20 nm, number of pores in membrane surface: 6.0×10¹⁴ (6.0E14) pores/m² on average, thickness: 0.15 mm. The number of membrane modules used was one. The membrane area of the membrane module was 30 m².

The average pore size, the opening ratio, and the number of pores were determined by dividing a hollow fiber into 5 segments in the longitudinal direction, observing each of the segments at 50K-fold magnification with a scanning electron microscope in 100 fields of view, and averaging the results. Table 1 summarizes the measurement results.

The number of microparticles was measured at the inlet and outlet of the microparticle removal membrane device 17. Specifically, the number of microparticles having a size of 20 nm or more was measured with an online particle monitor Ultra-DI20 produced by Particle Measuring Systems. The number of microparticles having a size of 10 nm or more was measured with a microparticle gage based on a centrifugal filtration-SEM method at a measurement error of ±30%. Table 2 summarizes the results.

### Example 2

The measurement was made as in Example 1, except that the microparticle removal membrane used in Example 1 was changed to a filtration membrane in which the average number of pores formed in the surface of the hollow fiber membrane was 1.3E13 pores/m². Table 2 summarizes the results.

### Example 3

The measurement was made as in Example 1, except that the microparticle removal membrane used in Example 1 was changed to a filtration membrane in which the average number of pores formed in the surface of the hollow fiber membrane was 6.4E13 pores/m². Table 2 summarizes the results.

### Example 4

The raw water was treated as in Example 1, except that the system illustrated in FIG. 2 was used instead. The number of microparticles was measured at the inlet and outlet of the microparticle removal membrane device 17. Table 2 summarizes the results.

The catalytic oxidizing-substance decomposition device 14 disposed downstream of the UV oxidation device 13 was Nanosaver produced by Kurita Water Industries Ltd., which is a catalyst material on which platinum particles are deposited.

### Comparative Example 1

The measurement was made as in Example 1, except that the microparticle removal membrane used in Example 1 was changed to a UF membrane in which the average number of pores formed in the surface of the hollow fiber membrane was 1E12 pores/m². Table 2 summarizes the results.

### Comparative Example 2

The measurement was made as in Example 1, except that a concentration line was attached to the microparticle removal membrane device 17 used in Example 1 and the device was operated at a recovery rate of 90%. The number of microparticles was measured at the inlet and outlet of the microparticle removal membrane device 17. Table 2 summarizes the results.

### Comparative Example 3

The measurement was made as in Example 1, except that the system illustrated in FIG. 3 was used instead. The number of microparticles was measured at the inlet and outlet of the microparticle removal membrane device 17. Table 2 summarizes the results.

TABLE 1
[UF membrane used in Example 1]

| | | Average number of pores |
|---|---|---|
| | Pore size [μm] | over 100 fields of view |
| Number of | ~0.2 | 138 |
| pores by size | 0.2~0.4 | 34 |
| | 0.4~0.6 | 2 |

| | | |
|---|---|---|
| Total number of pores | 174 | pores/field of view |
| At 200K-fold magnification | 0.29 | μm²/field of view |
| Membrane area per hollow fiber | 0.003 | m²/fiber |
| Number of pores per m² ofmembrane | 6E+14 | pores/m² |

TABLE 2

| | Results of measurement of microparticles | | | |
|---|---|---|---|---|
| | Inlet of filtration | Outlet of filtration | | |
| | membrane | membrane | | Recovery |
| | [particles/mL | [particles/mL | [particles/mL | rate |
| | (>20 nm)] | (>20 nm)] | (>10 nm)] | [%] |
| Example 1 | 270 | 0.48 | 3 | 100 |
| Example 2 | 261 | 0.60 | 2 | 100 |
| Example 3 | 240 | 0.73 | 3 | 100 |
| Example 4 | 179 | 0.20 | ≤1 | 100 |
| Comparative | 258 | 0.70 | 4 | 100 |
| example 1 | | | | |
| Comparative | 271 | 0.55 | 2 | 90 |
| example 2 | | | | |
| Comparative | 2,200 | 4.4 | 36 | 100 |
| example 3 | | | | |

### Discussions

Table 2 summarizes the numbers of microparticles measured by the online particle monitor and the centrifugal filtration-SEM method and the transmembrane pressures measured.

The treatment performed in Comparative example 1 is considered acceptable in terms of the number of microparticles because the number of microparticles measured at the outlet of the filtration device in Comparative example 1 was substantially equal to the numbers of microparticles measured in Examples 1 to 3. However, the increase in transmembrane pressure described below indicates that the treatment performed in Comparative example 1 is not appropriate. This confirms that it is suitable to set the number of pores formed in the surface of the membrane to be 1E13 to 1E15 pores/m².

The numbers of microparticles measured at the outlet of the microparticle removal membrane in Examples 1 to 3 and Comparative example 2 were equal to one another. This shows that operating the device in a dead-end filtration mode does not result in degradation in the water qualities.

A comparison between the results obtained in Examples 1 to 3 and the results obtained in Comparative example 3 confirms that the concentration (the number of microparticles) at the inlet of the filtration membrane affects the water qualities at the outlet of the filtration membrane. It is also confirmed that the number of microparticles at the inlet of the filtration membrane is preferably 1,000 particles/mL or less (particle size: 20 nm or more) as measured in terms of 60-minute average with a 20-nm online particle counter.

A comparison between the results obtained in Examples 1 to 3 and the results obtained in Example 4 confirms that, in the case where a catalytic oxidizing-substance decomposition device is disposed downstream of the UV oxidation device, hydrogen peroxide generated in the UV oxidation device can be effectively decomposed in the catalytic oxidizing-substance decomposition device. This limits the likelihood of an ion-exchange resin included in the mixed-bed ion-exchange device disposed downstream of the catalytic oxidizing-substance decomposition device becoming degraded by oxidation and generating dust microparticles and thereby reduces the load placed on the filtration membrane. Consequently, the number of microparticles present in the water treated through the filtration membrane can be reduced.

### Test I (Test of Filtration of Silica Nanoparticle-Containing Water)

In this test, water containing silica nanoparticles was filtered through each of the microparticle removal membrane devices used in Examples 1 to 4 and Comparative examples 1 to 3 above and increases in pressure difference were measured.

A supply port for chemical injection was disposed in the immediate vicinity of each of the microparticle removal membrane devices used in Examples 1 to 4 and Comparative examples 1 to 3. Subsequently, silica nanoparticles (“Ludox TMA” produced by Sigma-Aldrich) having a size of 20 nm were injected to the water at a concentration of 0.02 mg/L with a syringe pump in order to place a concentration load on the microparticle removal membrane devices which is equivalent to five or more years of loading in terms of the number of microparticles. The transmembrane pressure of each of the microparticle removal membrane devices which occurred during the injection of the silica nanoparticles was measured with a digital pressure gage GC64 produced by NAGANO KEIKI CO., LTD.

Table 3 summarizes the transmembrane pressures after a lapse of three years which were calculated using the transmembrane pressures measured. The results shown in Table 3 confirm that the transmembrane pressure was disadvantageously increased under the conditions of Comparative examples 1 and 3. The calculation of the transmembrane pressure was done by the following method.

### Calculation of Transmembrane Pressure

A change in the proportion of pores in the surface of the membrane which occurs while the feed containing microparticles having a size of 20 nm at a concentration of 1,000 particles/mL is passed through an ultrafiltration membrane having pores formed in the surface which have an average size of 20 nm, the UF membrane having a thickness of 150 μm and an area of 30 m²/module, at 10 m³/h for 3 years was determined on the assumption that the membrane becomes clogged with microparticles that uniformly adhere on the surface of the membrane. Subsequently, a change in transmembrane pressure which is caused by the microparticles is calculated from the flow rate through the pores, the size of the pores, and the viscosity using the Hagen-Poiseuille formula.

Calculation formula for the proportion of pores in membrane surface (Formula 1)

R=(QTCp/N)×100 (Formula 1)

where,

R: Proportion of pores in membrane surface [%]

Q: Permeate flow rate [m³/h]

T: Permeation time [h]

Cp: Concentration of microparticles [particles/m³]

N: Area of pores included in entire module [m²]

Hagen-Poiseuille approximation formula (Formula 2)

ΔP=32μLu/D² (Formula 2)

ΔP: Transmembrane pressure [Pa]

μ: Viscosity [Pa·s]

L: Thickness [m]

u: Pore permeation flux [m/sec]

D: Pore size [m]

TABLE 3

| | Calculated transmembrane pressure |
|---|---|
| | ΔP after lapse of three years |
| | [MPa] |
| Example 1 | <0.1 |
| Example 2 | <0.1 |
| Example 3 | <0.1 |
| Example 4 | <0.1 |
| Comparative | 0.12 |
| example 1 | |
| Comparative | <0.1 |
| example 2 | |
| Comparative | 0.12 |
| example 3 | |

### Test II (Test of Filtration of Water Containing Gold Colloid Particles)

A water containing gold colloid particles was filtered through a microparticle removal membrane device that included the following membrane A, B, or C (the microparticle removal membrane device had the same structure as that used in Example 1, except that the membrane was changed).

Membrane A: Polyketone membrane having a pore size of 0.1 μm

Membrane B: Polyketone membrane having a pore size of 0.1 μm to which a dimethylamino group had been introduced, which was prepared by immersing a polyketone membrane formed by a publicly known method (JP 2013-76024 A or WO 2013-035747 A) in an aqueous N,N-dimethylamino-1,3-propylamine solution containing a small amount of acid, heating the resulting polyketone membrane, subsequently cleaning the polyketone membrane with water and methanol, and drying the cleaned polyketone membrane.

Membrane C: The ultrafiltration membrane used in Example 1

A gold colloid (“EMGC50 (average particle size: 50 nm, CV<8%)” produced by BB International) having a particle size of 50 nm was passed through the microparticle removal membrane device at 0.5 L/min. The concentration of the gold colloid particles in the permeate was measured. The rejection rate of the membrane was determined. Table 4 summarizes the results.

### Test III (Test of Filtration of Water Containing Gold Colloid Microparticles)

A test was conducted as in Test II, except that a gold colloid (“EMGC10 (average particle size: 10 nm, CV<10%)” produced by BB International) having a particle size of 10 nm was passed through the microparticle removal membrane device. The concentration of the gold colloid particles in the permeate was measured. The rejection rate of the membrane was determined. Table 4 summarizes the results. The concentration of the gold colloid particles was measured by ICP-MS.

### Test IV (Measurement of Amounts of Dust Particles Generated From Membranes A to C)

A branch pipe was attached to the permeate draw pipe of a microparticle removal membrane device (having the same structure as in Example 1) that included the membrane A, B, or C that had not been used. An online particle monitor Ultra-DI20 produced by Particle Measuring Systems was attached to the branch pipe. Ultrapure water was passed through the microparticle removal membrane device such that a flux of 10 m³/m²/day was achieved. The amount of dust particles having a size of 20 nm or more which were generated from the membrane was measured. The 60-minute average of the amount of dust particles was calculated. Table 4 summarizes the results.

TABLE 4

| | Test II | | Test III | | |
|---|---|---|---|---|---|
| | (50 nm gold colloid) | | (10 nm gold colloid) | | Test IV, amount of dust particles |
| | Permeate | Rejection | Permeate | Rejection | (size: 20 nm or more) |
| | concentration | rate | concentration | rate | Number of microparticles |
| Membrane | [ppt] | [%] | [ppt] | [%] | [particles/mL (60-minute average)] |
| A: Polyketone | 420 | 97.9 | 12,000 | 40 | 2 |
| membrane | | | | | |
| B: Dimethylamino | 1 | 99.995 | 2 | 99.99 | <0.01 |
| group-modified | | | | | |
| polyketone membrane | | | | | |
| C: Ultrafiltration | 0.2 | 99.999 | 0.4 | 99.995 | 0.1 |
| membrane | | | | | |

### Discussions

As shown in Table 4, the membrane B (dimethylamino group-modified polyketone membrane) was capable of rejecting even gold colloid particles having a size of 10 nm at a rejection rate of 99.99%. This confirms that a membrane that includes a weakly cationic functional group is effective for removing microparticles. A comparison between the amounts of dust particles generated from the test membranes shows that the dimethylamino-modified polyketone membrane generated the smallest amount of dust particles. This confirms that introducing a weakly cationic functional group, such as a dimethylamino group, to a polyketone membrane increases the microparticle removal capability of the polyketone membrane and reduces the amount of dust particles generated from the membrane. Consequently, permeate having qualities comparable to or higher than those of the permeate through an unmodified ultrafiltration membrane may be produced. Needless to say that the advantageous effects produced by modifying a polyketone membrane with a cationic functional group may also be achieved when an ultrafiltration membrane is modified with a cationic functional group.

Although the present invention has been described in detail with reference to particular embodiments, it is apparent to a person skilled in the art that various modifications can be made therein without departing from the spirit and scope of the present invention.

The present application is based on Japanese Patent Application No. 2016-062177 filed on Mar. 25, 2016, which is incorporated herein by reference in its entirety.

1. An ultrapure-water production system comprising an auxiliary treatment apparatus and a dead-end filtration apparatus that treats water treated by the auxiliary treatment apparatus,
the auxiliary treatment apparatus treating water such that the number of microparticles present in water treated by the auxiliary treatment apparatus is 800 to 1200 particles/mL (particle size: 20 nm or more), the number of microparticles being measured by a 60-minute moving average method with an online particle monitor Ultra-DI20 produced by Particle Measuring Systems capable of measuring microparticles having a size of 20 nm with a detection sensitivity of 5% and a measurement error of ±20%, the online particle monitor receiving the water treated by the auxiliary treatment apparatus through a sampling cock disposed on a main pipe,
the dead-end filtration apparatus including a filtration membrane, the filtration membrane being a microfiltration membrane having pores with a size of 0.05 to 1 μm, the pores being formed in the surface of the membrane at an opening ratio of 50% to 90%, the microfiltration membrane having a thickness of 0.1 to 1 mm, or an ultrafiltration membrane having pores with a size of 0.005 to 0.05 μm, the pores being formed in the surface of the membrane, the number of the pores being 1E13 to 1E15 pores/m², the ultrafiltration membrane having a thickness of 0.1 to 1 mm, the ultrafiltration membrane having a transmembrane pressure of 0.02 to 0.10 MPa at a permeation flux of 10 m³/m²/d.

2. The ultrapure-water production system according to claim 1, wherein the dead-end filtration apparatus has a membrane area of 10 to 50 m² and the amount of water that passes through the dead-end filtration apparatus per membrane module is 10 to 50 m³/h.

3. The ultrapure-water production system according to claim 1, wherein the dead-end filtration apparatus is an outside-in hollow fiber membrane module.

4. The ultrapure-water production system according to claim 1, wherein the filtration membrane includes a cationic functional group.

5. The ultrapure-water production system according to claim 4, wherein 50% or more of the membrane includes a weakly cationic functional group.

6. The ultrapure-water production system according to claim 4, wherein an amount of the cationic functional group included in the membrane is 0.01 to 1 milliequivalents per gram of the membrane.

7. The ultrapure-water production system according to claim 1, wherein the auxiliary treatment apparatus includes a feed pump and a mixed-bed ion-exchange device that are arranged in this order from upstream to downstream, and wherein the dead-end filtration apparatus treats water treated by the mixed-bed ion-exchange device.

8. The ultrapure-water production apparatus system according to claim 7, wherein the auxiliary treatment apparatus further includes a UV oxidation device and a catalytic oxidizing-substance decomposition device that are arranged upstream of the feed pump in this order from upstream to downstream.
